(19) United States
(12) Patent Application Publication
(10) Pub. No.: US 2007/0274385 A1
(43) Pub. Date: Nov. 29, 2007

(54) Method of increasing coding efficiency and reducing power consumption by on-line scene change detection while encoding inter-frame

(76) Inventor: Zhongli He, Austin, TX (US)

Correspondence Address: HAMILTON & TERRILE, LLP, P.O. BOX 203518, AUSTIN, TX, 78720, US

(21) Appl. No.: 11/441,869

(22) Filed: May 26, 2006

(51) Int. Cl. H04N 7/12; H04N 11/04

(52) U.S. Cl. 375/240.12; 375/240.24

(57) ABSTRACT

A system and method for on-the-fly detection of scene changes within a video stream through statistical analysis of a portion of the macroblocks comprising each video frame as they are processed using inter-frame coding. If the statistical analysis of the selected macroblocks of the current frame differs from the previous frame by exceeding predetermined thresholds, the current video frame is assumed to be a scene change. Once a scene change is detected, the remainder of the video frame is encoded as an intra-frame, intra-macroblocks, or intra slices, through implementation of one or more predetermined or adaptively adjusted quantization parameters to reduce computational complexity, decrease power consumption, and increase the resulting video image quality. As decoding is the inverse of encoding, these improvements are similarly recognized by a decoder as it decodes a resulting encoded video stream.

### BACKGROUND OF THE INVENTION

1. Field of the Invention

The present invention relates in general to the field of video stream encoding, and more specifically, to detecting a scene change within a video stream.

2. Description of the Related Art

The use of digitized video continues to gain acceptance for use in a variety of applications including high definition television (HDTV) broadcasts, videoconferencing with personal computers, delivery of streaming media over a wireless connection to a personal digital assistant (PDA), and interpersonal video conversations via cellular phone. Regardless of how it is used, implementation of digitized video in each of these devices is typically constrained by screen size and resolution, processor speed, power limitations, and the communications bandwidth that is available. Advances in video compression have helped address some of these constraints, such as facilitating the optimal use of available bandwidth. However, computational overhead, power consumption and image quality can still be problematic for some devices when encoding video streams, especially those containing frequent scene changes.

In general, there is relatively little change from one video frame to the next unless the scene changes. Video compression identifies and eliminates redundancies in a video stream and then inserts instructions in their place for reconstructing the video stream when it is decompressed. Similarities between frames can be encoded such that only temporal changes between frames, or spatial differences within a frame, are registered in the compressed video stream. For example, inter-frame compression exploits the similarities between successive video frames, known as temporal redundancy, while intra-frame compression exploits the spatial redundancy of pixels within a frame. While inter-frame compression is commonly used for encoding temporal differences between successive frames, it typically does not work well for scene changes due to the low degree of temporal correlation between frames from different scenes. Intra-frame coding, which uses image compression to reduce spatial redundancy within a frame, is better suited for encoding video frames containing scene changes.

However, the encoder must first determine whether the scene has changed before intra-frame encoding can be applied to the frame being processed. Prior art approaches for detecting scene changes within a video stream include comparing the entire contents of a temporal residual frame with a predetermined reference before the frame is coded, which requires additional CPU cycles and decreases encoding efficiency. Another approach processes a set of successive video frames in two passes to determine the ratio of bi-directional (B) and unidirectional (P) motion compensated frames to be encoded. While an impulse-like increase in motion costs can indicate a screen change in the video stream, the computational complexity of the approach is not well suited to wireless video devices. Frequent scene changes within a video stream can further increase the number of processor cycles, consume additional power, and further degrade encoding efficiency. In view of the foregoing, there is a need for improved detection of scene changes in a video stream that does not require pre-processing the entire contents of each video frame before the most appropriate encoding method can be implemented.

### BRIEF DESCRIPTION OF THE DRAWINGS

The present invention may be understood, and its numerous objects, features and advantages obtained, when the following detailed description is considered in conjunction with the following drawings, in which:

FIG. 1 is a generalized block diagram depicting a prior art system for motion compensated video compression;

FIG. 2 is a generalized block diagram depicting a prior art system for changing video encoding modes when scenes change within a video stream;

FIG. 3 is a generalized block diagram of a video stream scene change detection system as implemented in accordance with an embodiment of the invention;

FIG. 4 is a generalized block diagram of a video stream scene change detection system as implemented in a video encoder system in accordance with an embodiment of the invention;

FIG. 5 is a generalized block diagram of a video stream scene change detection system as implemented in a video decoder system in accordance with an embodiment of the invention; and

FIG. 6 is a table depicting observed performance of a video stream scene change detection system as implemented in accordance with an embodiment of the invention.

Where considered appropriate, reference numerals have been repeated among the drawings to represent corresponding or analogous elements.

### DETAILED DESCRIPTION

A system and method is described for on-the-fly detection of scene changes within a video stream through statistical analysis of a portion of each video frame's macroblocks as they are processed using inter-frame encoding, thereby allowing the entire or the remainder of the macroblocks in the inter-frame to be encoded as an intra-frame, intra-slices, or intra-macroblocks, using adaptively adjusted or predetermined quantization parameters (QP) to reduce computational complexity, increase video coding efficiency, and improve video image quality.

Various illustrative embodiments of the present invention will now be described in detail with reference to the accompanying figures. While various details are set forth in the following description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are depicted with reference to simplified drawings in order to avoid limiting or obscuring the present invention. Such descriptions and representations are used by those skilled in the art to describe and convey the substance of their work to others skilled in the art. Various illustrative embodiments of the present invention will now be described in detail with reference to the figures.

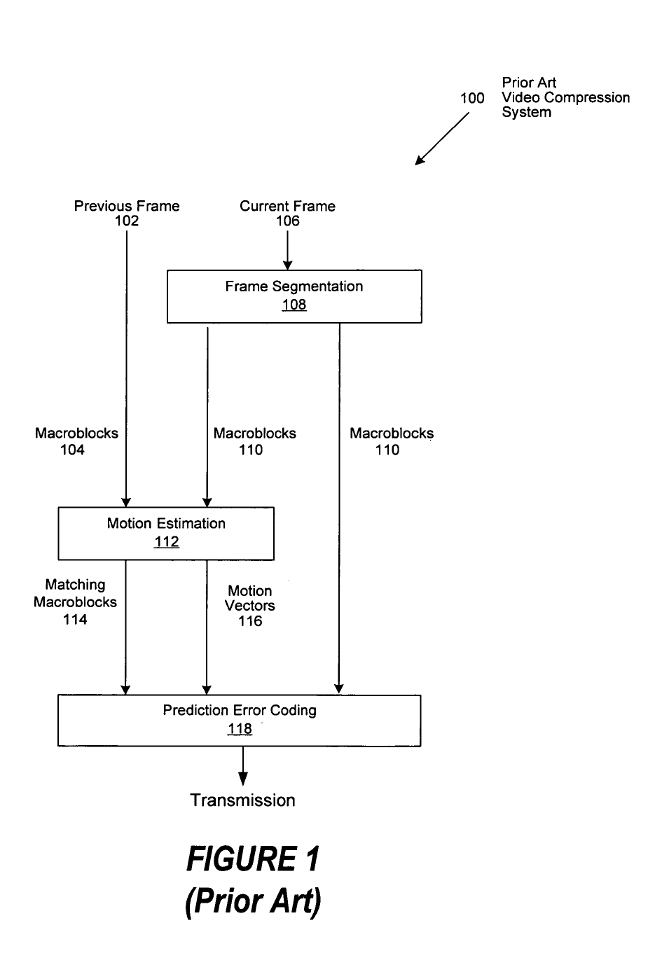

FIG. 1 is a generalized block diagram depicting a prior art system 100 for performing compensated video compression. In this depiction, a previous video frame 102 of a video stream, comprising a plurality of macroblocks 104, serves as a reference frame for current video frame 106. The current video frame 106 is segmented by frame segmentation module 108 into a plurality of macroblocks 110, typically 16×16 pixels in size. The previous frame 102 and the macroblocks 110 are provided to a motion estimation module 112 which performs a search to find macroblocks within previous video frame 102 that correspond to macroblocks 110 in the current frame 106. If found, candidate matching macroblocks 114 in previous video frame 102 are used as a substitute for corresponding macroblocks 110 in current frame 106 when it is reconstructed during decompression.

If the difference between the target macroblock in current frame 106 and the candidate macroblock at the same position in previous frame 102 is below a predetermined value, it is assumed that no motion has taken place and a zero vector is returned, thereby avoiding the computational expense of a search. If, however, the difference between the target macroblock in the current frame 106 and the candidate macroblock at the same position in the previous frame 102 exceeds the predetermined value, a search is performed to locate the best macroblock in the previous frame 102 and the corresponding macroblock in the current frame 106. The motion estimation module 112 then calculates motion vectors 116 that describe the location of the matching macroblocks in previous frame 102 with respect to the position of corresponding macroblocks 114 in current frame 106. Calculated motion vectors 116 may not correspond to the actual motion in the video stream due to noise and weaknesses in the matching algorithm and, therefore, may be corrected by the motion estimation module 112 using techniques known to those of skill in the art. The matching macroblocks 114, motion vectors 116, and corresponding macroblocks 110 are provided to the prediction error coding module 118 for predictive error coding and transmission.

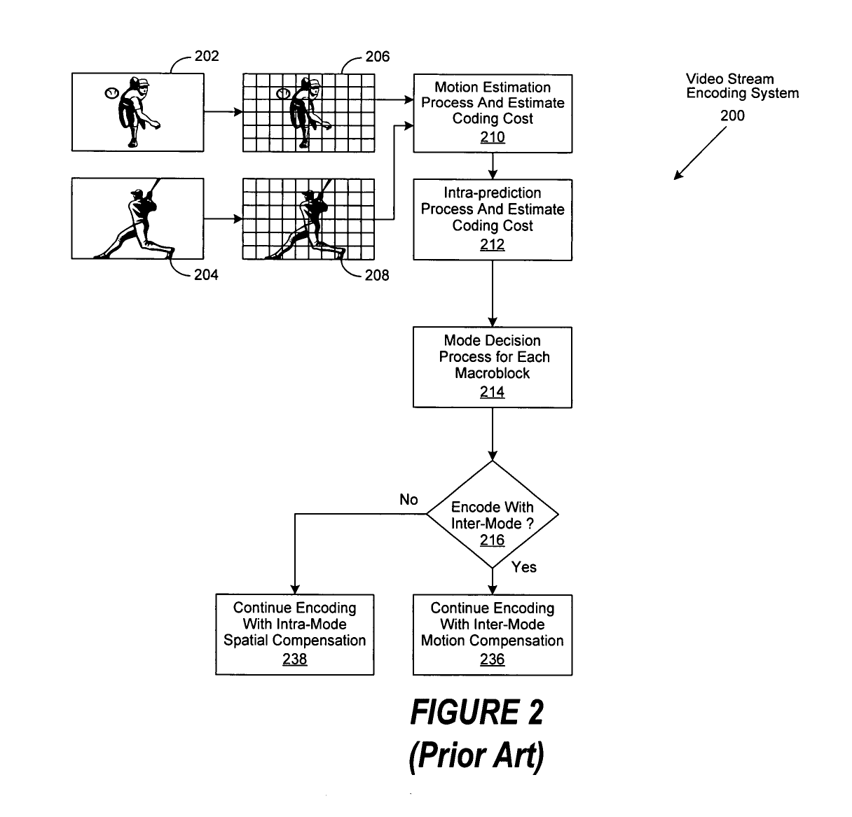

FIG. 2 is a generalized block diagram depicting a prior art video stream encoding system 200 for changing video encoding modes when scenes change within a video stream. Previous video frame 202 and current video frame 204 depict a scene change in a video stream that is being encoded. Encoded macroblocks 206 comprising a previous video frame 202 are used for reference and serve as a reference for current video frame 204, which is segmented into macroblocks 208, typically 16×16 pixels in size. Macroblocks of current video frame 208 reference macroblocks of previous video frame 206 for inter-frame motion estimation encoding 210 and estimation of computational coding costs, with intra-prediction encoding and associated computational costs 212 taking place thereafter before routing to encoding mode decision module 214. If encoding mode decision module 214, based on intra-prediction encoding 212 and associated computational cost estimates, determines in step 216 to encode a macroblock in the current video frame 204 using inter-macroblock mode for coding with motion compensation, then this macroblock in the video frame 204 is encoded using inter-macroblock mode with motion compensation. Otherwise, this macroblock in video frame 204 is encoded using intra-macroblock mode for coding with spatial compensation, with the process continuing until encoding of the all the macroblocks in a video frame.

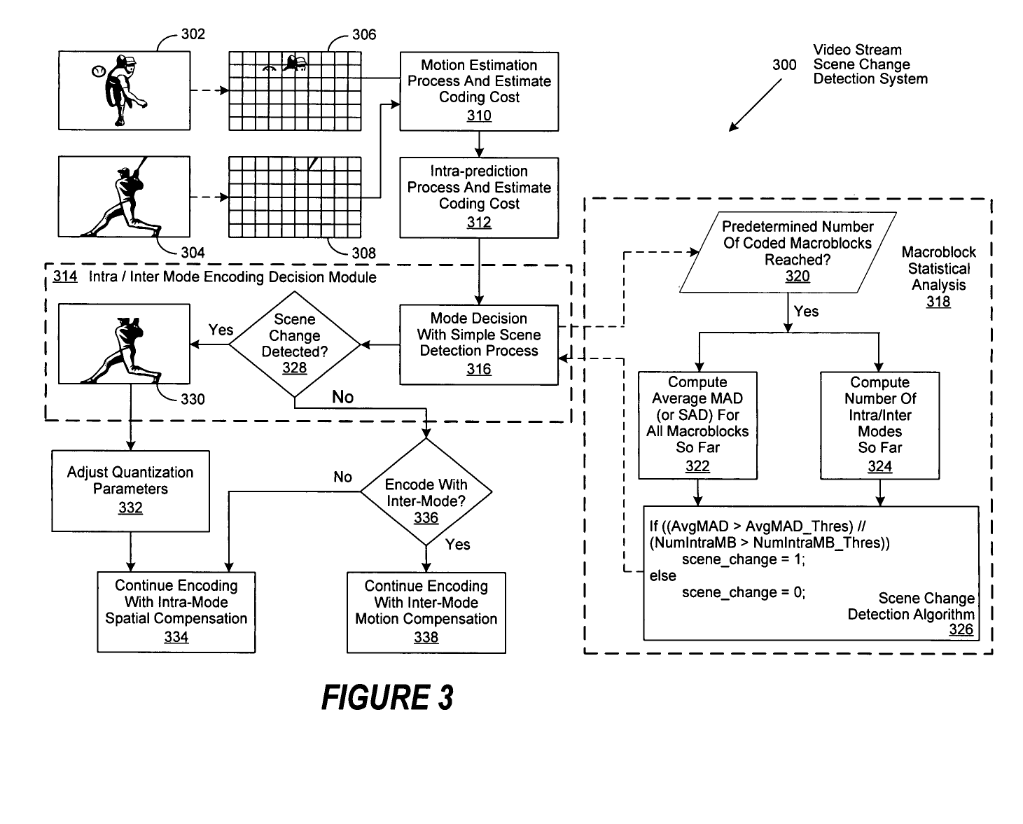

FIG. 3 is a generalized block diagram of video stream scene change detection system 300 implemented in accordance with an embodiment of the invention. Previous video frame 302 and current video frame 304 depict a scene change in a video stream that is being encoded. In various embodiments of the invention, a portion (e.g., ˜15%) of the encoded macroblocks 306 comprising a previous video frame 302 are used for on-the-fly analysis and comparison to a smaller portion (e.g., ˜10%) of macroblocks 308 comprising the current video frame 304 to determine if current video frame 304 contains a scene that is different (i.e., a scene change) from the scene contained in previous video frame 302. In one embodiment of the invention, the portion of the macroblocks 308 used for on-the-fly analysis and comparison is a macroblock row (e.g., a 352×16 pixel portion of a 352×288 video frame), half of a macroblock row, or a 1.5 macroblock row according to predetermined parameters. In other embodiments of the invention, the portion of the macroblocks 308 used for on-the-fly analysis and comparison is a 64×64 pixel array located in the center of a video frame, a predetermined region of interest within the video frame, or another position within the video frame as determined by flexible-macroblock-order (FMO).

As macroblocks 308 of current video frame 304 are captured for encoding, macroblocks 306 of previous video frame 302 are used in process step 310 as references for inter-frame motion estimation and estimation of computational coding costs. Next, intra-prediction encoding and associated computational cost calculations are performed in step 312. The processed data is then routed to the scene change detection and mode decision module 316 in the intra/inter mode encoding decision module 314.

The scene change detection and mode decision module 316 is operable to process macroblocks using a statistical analysis process 318 to optimize detection of a scene change. Once a predetermined number of macroblocks N has been encoded in process step 320, they are processed for statistical analysis in step 322 to compute the average mean-absolute-difference (MAD) or sum-of-absolute-difference (SAD) 322. They are also processed in step 324 by computing the number of intra/inter modes 324. Since this information is provided as part of the encoding process, no additional computational overhead is incurred. The resulting statistical data is then processed using a scene change detection algorithm in step 326 once the encoded number of macroblocks reaches N, such as:

```
If ((AvgMAD > AvgMAD_Thres) ||
  (NumIntraMB > NumIntraMB_Thres))
    scene_change = 1;
else
    scene_change = 0;
```

where AvgMAD is the average MAD for the predetermined number of encoded macroblock N and the AvgMAD_Thres is the predetermined threshold value for it, NumIntraMB is the number of macroblocks encoded in Intra mode among the number of encoded N macroblocks, the NumIntraMB_Thres is the predetermined threshold value for it. Scene change detection algorithm in Step 326 determines if current video frame 304 contains a scene that is different (i.e., a scene change) from the scene contained in previous video frame 302. The results of scene change detection algorithm 326 are then forwarded by mode decision with scene detection module 316 to decision process 328 where a determination is made of whether a scene change has occurred. If the result of decision process 328 is a determination that a scene change has occurred, the remaining (e.g., ˜90%) of the macroblocks of current video frame 304 are processed by adjusting quantization parameters in process step 332 and encoding continues with intra-frame spatial compensation in step 334. If, however, the result of the decision in process step 328 indicates that a scene change has not been detected, then processing proceeds to step 336 following the conventional coding approach to encode the remaining (e.g. ˜90%) macroblocks of current video frame 304 using inter-frame coding techniques to determine whether a macroblock is encoded in intra mode or inter mode based on the mode decision result. If the result of the decision in step 336 is to process using intermode, processing proceeds to step 338 where inter-mode processing techniques are applied. Otherwise, processing proceeds to step 334, where the macroblocks are processed using intra-mode spatial compensation techniques.

In different embodiments of the invention, scene change detection and optimal encoding mode selection can be implemented with video standards based on MPEG/ITU video encoding standards based on constant or variable bit rate (CBR/VBR), including but not limited to, MPEG-4 part 2 (MPEG4 video), MPEG-4 part 10 (AVC/H.264 video), H.263, MPEG-2, and scalable video coder. In another embodiment of the invention, coding efficiency and video image quality is improved by automatically inserting a key-frame for a video retrieval system, such as MPEG-7, and a video summary.

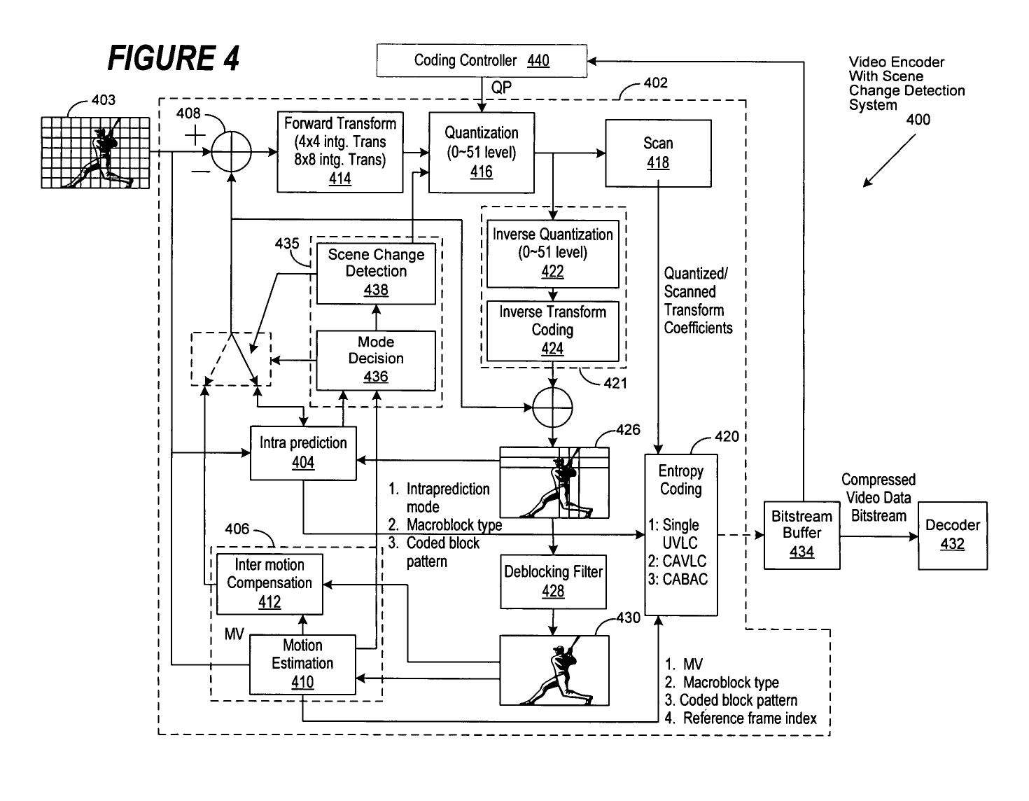

FIG. 4 is a generalized block diagram of a video stream scene change detection system 400 as implemented in a video encoder system in accordance with an embodiment of the invention. Encoder 402 converts the uncompressed video input data 403 into a compressed video data bitstream. The uncompressed video input data is provided to intra prediction module 404, interceding module 406, and a summer 408. Intercoding module 406 includes a motion estimation module 410 that, in at least one embodiment, operates to produce a motion vector (“MV”). The motion vector is used by intermotion compensation module 412 and is encoded by entropy coding block 420. Summer 408 determines the difference between the uncompressed video data 403 and either intra-prediction data or inter-motion data as selected by intra/inter mode decision module 435, comprising mode decision module 436 and scene change detection module 438.

Intra/inter mode decision module 435 in the embodiment illustrated in FIG. 4 comprises similar processing features described in greater detail hereinabove with regard to intra/inter mode decision module 314 of FIG. 3. In the embodiment of the invention shown in FIG. 4, intra/inter mode decision module 435 counts the number of intra-mode macroblocks comprising a predetermined number (e.g., ˜10%) of encoded macroblocks within current video frame 403. If the number of intra-frame macroblocks exceeds a predetermined threshold, then intra/inter mode decision module 435 determines that current video frame 403 contains a scene change. When a scene change is detected, the remaining macroblocks (e.g., ˜90%) of current video frame 403 are encoded using intra-mode coding, which requires no motion estimation or compensation, thus reducing computational overhead and power consumption. At the same time, adaptively adjusted or predetermined quantization parameter values will be applied to favor either spatial or temporal resolution based on the content comprising current video frame 403.

The difference (or residual) data between the uncompressed video data (original video data) and the predicted data is transformed by forward transform module 414 using for example a discrete cosine transform (“DCT”) algorithm. The coefficients from the DCT transformation are scaled to integers and quantized by quantization module 416. Coding controller 440 controls the quantization step size via control quantization parameter QP supplied to quantization module 416. The quantized transform coefficients are scanned by scan module 418 and entropy coded by entropy coding module 420. Entropy coding module 420 can employ any type of entropy encoding such as Universal Variable Length Codes (“UVLC”), Context Adaptive Variable Length Codes (“CAVLC”), Context-based Adaptive Binary Arithmetic Coding (“CABAC”), or combinations thereof. Entropy coded transform coefficients and intra/inter coding information (i.e. either intra-prediction mode or inter-prediction mode information) are transmitted along with motion vector data for future decoding. When intra prediction module 404 is associated with the current entropy encoded transform coefficients, the intraprediction mode, macroblock type, and coded block pattern are included in the compressed video data bitstream. When the interceding module 406 is associated with the current entropy encoded transform coefficients, the determined motion vector, macroblock type, coded block pattern, and reference frame index are included in the compressed video data.

Encoder 402 also includes decoder 421 to determine predictions for the next set of image data. Thus, the quantized transform coefficients are inversed quantized by inverse quantization module 422 and inverse transform coded by inverse transform coding module 424 to generate a decoded prediction residual. The decoded prediction residual is added to the predicted data. The result is motion compensated video data 426, which is provided directly to intraprediction module 404. Motion compensated video data 426 is also provided to deblocking filter 428 which deblocks the video data 426 to generate deblocked video data 430, which is fed into interceding module 406 for potential use in motion compensating the current image data.

The compressed video data bitstream produced by entropy coding module 420 is processed by bitstream buffer 434, which is coupled to coding controller 406, which also comprises a rate control engine, which operates to adjust quantization parameters to optimize the processing of video compression while maintaining a given bitrate. The compressed video data bitstream is ultimately provided to decoder 432, which uses information in the compressed video data bitstream to reconstruct uncompressed video data. In one embodiment of the invention, the encoder 402 and decoder 432 encode and decode video data in accordance with the H.264 /MPEG-4 AVC video coding standard.

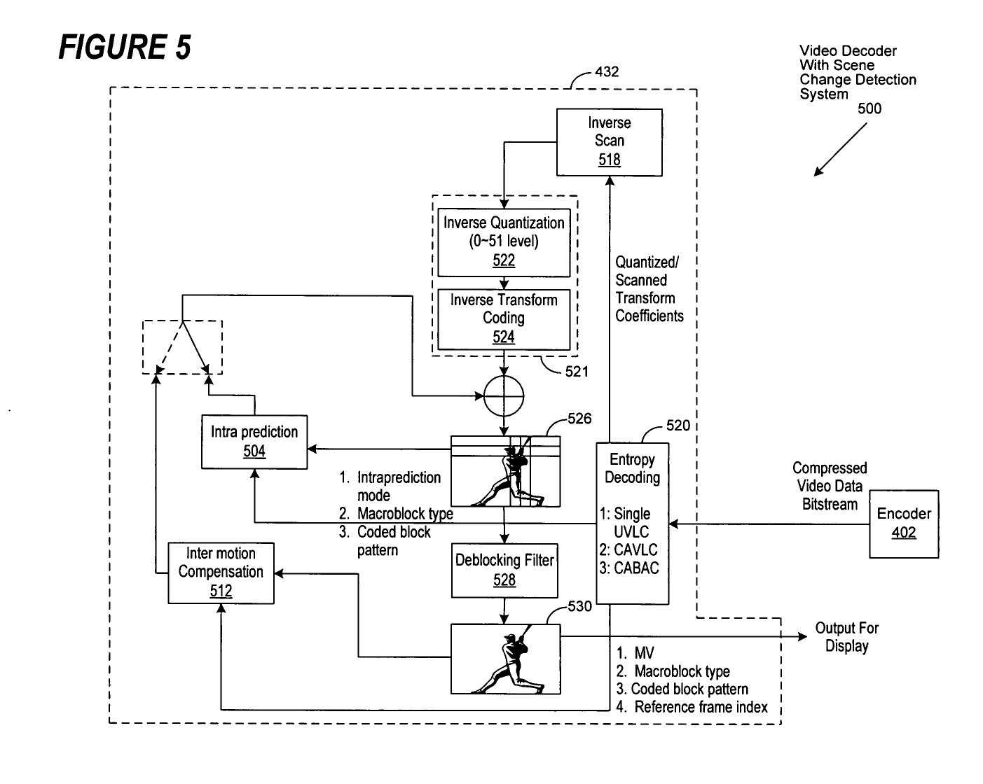

FIG. 5 is a generalized block diagram of a video stream scene change detection system as implemented in a video decoder system in accordance with an embodiment of the invention. Video decoding is essentially the inverse of video encoding. A compressed video bitstream is received from encoder 402, described in greater detail hereinabove, which is entropy decoded by entropy decoding block 520 and reordered by inverse scan module 518 to produce a set of quantized coefficients, which are rescaled, inverse transformed and quantized by decoder 521, comprising inverse quantization module 522 and inverse transform coding module 524. Resulting motion compensated video data 526 is provided to intraprediction module 504. Motion compensated video data 526 is also provided to deblocking filter 528 which deblocks the video data 526 to generate deblocked video data 530, which is fed into inter motion compensation module 512 for motion compensating the current image data. Video coding benefits from the dynamic computation adjustment reduce the amount of processing needed for coding. Since decoder 432 performs a reverse process of encoder 402, computation reductions by encoder 402 are shared by decoder 432, resulting in reduced computational complexity and overhead, lower power consumption, and improved video image quality.

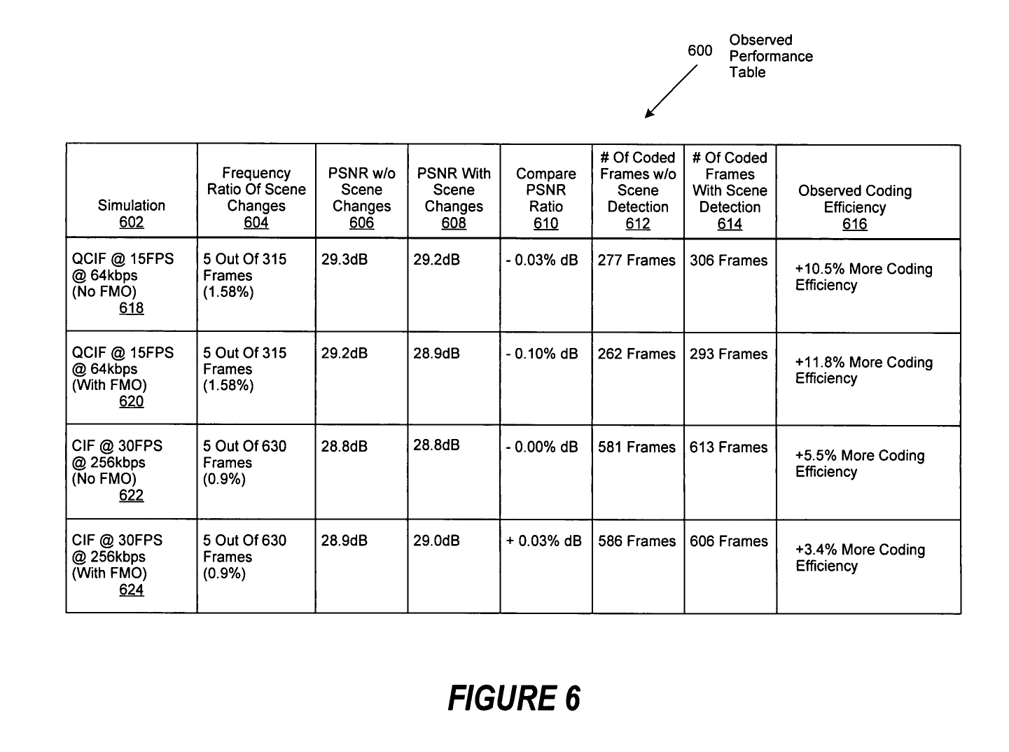

FIG. 6 is a table depicting observed performance of a video stream scene change detection system as implemented in accordance with an embodiment of the invention. Observed performance table 600 comprises simulated video stream scene change detection tests 602, frequency ratio of frames containing scene changes within the simulated video test stream 604, peak signal-to-noise ratio (PSNR) of the simulated video test stream without scene changes 606, PSNR of the simulated video test stream with scene changes 608, comparative PSNR ratio 610, the number of coded frames of the simulated video test stream without scene changes 612, the number of coded frames of the simulated video test stream with scene changes 614, and observed improvements in coding efficiency 616. By way of example, these tests are for low delay video encoding which allows frame dropping.

Simulated video stream scene change detection tests 602 comprise quarter common intermediate format (QCIF) at 15 frames per second (FPS) processed at 64 kilobits per second (kbps) without implementation of flexible-macroblock-order (FMO) 618, QCIF at 15FPS processed at 64 kbps with implementation of FMO 620, common intermediate format (CIF) at 30FPS processed at 256 kbps without implementation of FMO 622, and CIF at 30FPS processed at 256 kbps with implementation of FMO 624. QCIF video stream scene change detection test 618, conducted at 15FPS and processed at 64 kbps without implementation of FMO, comprises 315 video frames, of which 5 (1.58%) contain scene changes, with a measured peak signal-to-noise ration (PSNR) of 29.3 dB without scene changes and 29.2 dB with, resulting in a PSNR ratio of −0.03% dB, measured 277 encoded frames without scene detection and 306 with, for a 10.5% increase in encoding efficiency. QCIF video stream scene change detection test 620, conducted at 15FPS and processed at 64 kbps with implementation of FMO, comprises 315 video frames, of which 5 (1.58%) contain scene changes, with a measured PSNR of 29.2 dB without scene changes and 28.9 dB with, resulting in a PSNR ratio of −0.10% dB, measured 262 encoded frames without scene detection and 293 with, for a 11.8% increase in encoding efficiency. CIF video stream scene change detection test 622, conducted at 30 FPS and processed at 256 kbps without implementation of FMO comprises 630 video frames, of which 5 (0.98%) contain scene changes, with a measured PSNR of 28.8 dB without scene changes and 28.8 dB with, resulting in a PSNR ratio of −0.00% dB, measured 581 encoded frames without scene detection and 613 with, for a 5.5% increase in encoding efficiency. CIF video stream scene change detection test 624, conducted at 30 FPS and processed at 256 kbps with implementation of FMO comprises 315 video frames, of which 5 (1.58%) contain scene changes, with a measured PSNR of 28.9 dB without scene changes and 29.0 dB with, resulting in a PSNR ratio of −0.03% dB, measured 586 encoded frames without scene detection and 606 with, for a 3.4% increase in encoding efficiency.

In accordance with the present invention, a system and method has been disclosed for on-the-fly detection of scene changes within a video stream through statistical analysis of a portion of each video frame's macroblocks as they are processed using inter-frame encoding. In an embodiment of the invention, a method for improving detection of scene changes in a video stream, comprises: a) receiving a video data stream comprising a plurality of video data frames, wherein each of said frames comprises a plurality of macroblocks; b) initiating processing of a predetermined portion of the macroblocks in each video data frame in said plurality of data frames; and c) analyzing the processed portions of said macroblocks to determine whether the corresponding video frame should be processed using interframe processing protocols.

In various embodiments of the invention, when a scene change is detected, the macroblocks in the remaining portion of the frame are encoded as an intra-frame, intra-slices, or intra-macroblocks, using adaptively adjusted or predetermined quantization parameters (QP) to reduce computational complexity, increase video coding efficiency, and improve video image quality. Scene changes within a video stream are detected by statistical analysis of a small percentage (e.g., ˜10%) of the macroblocks comprising each video frame as they are processed using inter-frame coding. If the statistical analysis of the selected macroblocks of the current frame differs from the previous frame by exceeding predetermined thresholds, the current video frame is assumed to be a scene change.

In embodiments of the invention, the statistical information gathered from encoded macroblock samples includes, but is not limited to, mean-absolute-difference (MAD) or sum-of-absolute-difference (SAD), average length of motion vectors, number of intra/inter modes. As this information is provided as part of the encoding process, no additional computational overhead is incurred. In one embodiment of the invention, the analyzed area of the video frame is a macroblock row (e.g., a 352×16 pixel portion of a 352×288 video frame), half of a macroblock row, or a 1.5 macroblock row according to predetermined parameters. In other embodiments of the invention, the analyzed area is a 64×64 pixel array located in the center of a video frame, a predetermined region of interest within the video frame, or another position within the video frame as determined by flexible-macroblock-order (FMO).

Once a scene change is detected, the remainder of the video frame is encoded as an intra-frame, intra-macroblocks, or intra slices, through implementation of one or more predetermined or adaptively adjusted quantization parameters to reduce computational complexity, decrease power consumption, and increase the resulting video image quality. In a different embodiment of the invention, encoding of the inter-frame is restarted when a scene change is detected, with all macroblocks in the inter-frame being encoded as an intra-frame, intra-slices, or intra-macroblocks. This embodiment of the invention results in higher video image quality at the expense of incurring additional computational overhead, which is typically less than if all macroblocks in the video frame were inter-frame encoded.

The present invention can be implemented with video standards based on MPEG/ITU video encoding standards using constant or variable bit rate (CBR/VBR), including but not limited to, MPEG-4 part 2 (MPEG4 video), MPEG-4 part 10 (AVC/H.264 video), H.263, MPEG-2, and scalable video coder. In addition, coding efficiency and video image quality is improved by automatically inserting a key-frame for a video retrieval system, such as MPEG-7, and a video summary. Those of skill in the art will understand that many such embodiments and variations of the invention are possible, including but not limited to those described hereinabove, which are by no means all inclusive.

Although the described exemplary embodiments disclosed herein are directed to various examples of systems and methods for improving coding efficiency, the present invention is not necessarily limited to the example embodiments. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for improving detection of scene changes in a video stream, comprising:
receiving a video data stream comprising a plurality of video data frames, each of said frames comprising a plurality of macroblocks;
initiating processing of a predetermined portion of the macroblocks in each video data frame in said plurality of data frames; and
analyzing the processed portions of said macroblocks to determine whether the corresponding video frame should be further processed using interframe processing protocols.

2. The method of claim 1 wherein said analysis of said processing of said macroblocks comprises statistical analysis of a portion of said processed macroblocks.

3. The method of claim 2 wherein said statistical analysis of said processing comprises statistical analysis of a portion of a processed macroblock row.

4. The method of claim 2 wherein said statistical analysis of said processing comprises statistical analysis of a processed pixel array at a predetermined location in a video frame.

5. The method of claim 2 wherein said statistical analysis of said processing comprises mean-absolute-difference analysis of said processed portions of said macroblocks.

6. The method of claim 2.wherein said statistical analysis of said processing comprises sum-of-difference analysis of said processed portions of said macroblocks.

7. The method of claim 1 wherein said processing of said portion of said macroblock results in detection of a scene change.

8. A system for processing video data, comprising:
a video encoder operable to receive a video data stream comprising a plurality of video data frames, each of said frames comprising a plurality of macroblocks, said encoder further being operable to initiate processing of a predetermined portion of the macroblocks in each video data frame in said plurality of data frames; and
a scene change detector operable to analyze the processed portions of said macroblocks to determine whether the corresponding video frame should be further processed using interframe processing protocols.

9. The system of claim 8 wherein said scene change detector analysis of said processed portions of said macroblocks comprises statistical analysis of a portion of said processed macroblocks.

10. The system of claim 9 wherein said statistical analysis of said processed portions comprises statistical analysis of a portion of a processed macroblock row.

11. The system of claim 9 wherein said statistical analysis of said processed portions comprises statistical analysis of a processed pixel array at a predetermined location in a video frame.

12. The system of claim 9 wherein said statistical analysis of said processed portions comprises mean-absolute-difference analysis of said processed portions of said macroblock.

13. The system of claim 9 wherein said statistical analysis of said processed portions comprises sum-of-difference analysis of said processed portions of said macroblock.

14. The system of claim 8 wherein said processing of said portion of said processed portions results in detection of a scene change.

15. A method for improving detection of scene changes in a video stream, comprising:
receiving first and second video data frames from a video data stream, each of said first and second video data frames comprising a plurality of macroblocks;
initiating processing of a predetermined portion of the macroblocks in said second video data frame;
performing a statistical analysis of said predetermined portion of said macroblocks in said second video data frame to determine whether said second video data frame should be further processed using interframe processing protocols.

16. The method of claim 15.wherein said statistical analysis of said processing comprises statistical analysis of a portion of a processed macroblock row.

17. The method of claim 15 wherein said statistical analysis of said processing comprises statistical analysis of a processed pixel array at a predetermined location in a video frame.

18. The method of claim 15 wherein said statistical analysis of said processing comprises mean-absolute-difference analysis of said processed portions of said macroblock.

19. The method of claim 15 wherein said statistical analysis of said processing comprises sum-of-difference analysis of said processed portions of said macroblock.

20. The method of claim 15 wherein said statistical analysis of said portion of said macroblock results in detection of a scene change.
